(19) United States
(12) Patent Application Publication
(10) Pub. No.: US 2017/0006154 A1
(43) Pub. Date: Jan. 5, 2017

(54) MULTI-OPERATOR VECTORING IN DIGITAL SUBSCRIBER LINE MODEMS

(71) Applicant: Ikanos Communications, Inc., Fremont, CA (US)

(72) Inventors: Avadhani Shridhar, Santa Clara, CA (US); Shailendra Kumar Singh, Fremont, CA (US); William Edward Keasler, JR., Tinton Falls, NJ (US); Debajyoti Pal, Saratoga, CA (US)

(21) Appl. No.: 15/199,487

(22) Filed: Jun. 30, 2016

Related U.S. Application Data
(60) Provisional application No. 62/188,263, filed on Jul. 2, 2015.

(51) Int. Cl. H04M 3/34; H04Q 5/00; H04B 3/32

(52) U.S. Cl. CPC H04M 3/34; H04B 3/32; H04Q 5/00; H04Q 2201/14

(57) ABSTRACT

Methods, systems, and devices are described for wired communication. A first distribution point uses sets of modems to communicate with a second distribution point over a crosstalk link to exchange information and coordinate the use of multiple sets of frequency bands. In some cases, the first distribution point may share a cable binder with the second distribution point and detect crosstalk on the subscriber lines in the cable binder. Based at least in part on the crosstalk detected by the first distribution point, the first and second distribution points may communicate over a crosstalk link between sets of lines in the binder. The distribution points may use one or more sets of predefined tones within the multiple sets of frequency bands to exchange messages, where the messages may include synchronization information, operating parameters, or control and data information.

### CROSS REFERENCES

The present Application for Patent claims priority to U.S. Provisional Patent Application No. 62/188,263 by Shridhar et al., entitled “Multi-Operator Vectoring in FDD Modems,” filed Jul. 2, 2015, assigned to the assignee hereof, and expressly incorporated by reference herein.

### BACKGROUND

Field of the Disclosure

The present invention relates to digital subscriber line (DSL) communications, and more particularly to methods and devices for multi-operator vectoring in digital subscriber line (DSL) modems.

Description of Related Art

The rapid growth of the internet and the content available through the internet has increased the demand for high bandwidth connectivity. Digital subscriber line (DSL or xDSL) technology meets this demand by providing data service over twisted pair telephone lines. DSL can be deployed from central offices (COs), from fiber-fed cabinets located near the customer premises, or within buildings.

DSL systems typically include multiple bundles of twisted pair wires located within close proximity to each other. Because of the high frequencies involved, communication occurring on one wire may degrade or substantially disrupt communication on an adjacent wire by causing electromagnetically induced crosstalk on the adjacent wire. These crosstalk signals on neighboring wires can disrupt communications on the impacted wires. Vectoring techniques are thus used to mitigate crosstalk signals when multiple lines are present in a cable binder.

Multiple operators can share the same cable binder in some DSL deployments. In such cases, the operators may not want their CO boxes to be connected to the other operator's boxes, and an exchange of tone data is not possible between the boxes of the operators. If the lines from a first operator's box experience crosstalk from the lines of a second operator, and the crosstalk is not cancelled, line rates can drop significantly.

### SUMMARY

The described techniques relate to improved methods, systems, devices, or communication devices that support multi-operator vectoring in digital subscriber line (DSL) modems. Generally, the described techniques provide for methods to improve line rates for multi-operator DSL deployments. In some examples, a distribution point uses sets of modems to communicate over a crosstalk link to exchange information and coordinate the use of multiple sets of frequency bands. A first distribution point may share a cable binder with a second distribution point, and detect crosstalk on the subscriber lines in the cable binder. Based at least in part on the crosstalk detected by the first distribution point, the first and second distribution points may communicate over a crosstalk link between sets of lines in the binder. The distribution points may use one or more sets of predefined tones within the multiple sets of frequency bands to exchange messages, where the messages may include synchronization information, operating parameters, or control and data information.

A method of wireline communications is described. The method may include using a set of central office (CO) modems at a first distribution point to provide service to a first set of consumer premises equipment (CPE) modems over a first set of lines in a binder, wherein the binder further comprises a second set of lines associated with a second set of CPE modems serviced by a second distribution point, detecting crosstalk between the first set of lines and the second set of lines, and communicating, based at least in part on the detected crosstalk, with the second distribution point over a crosstalk link, wherein the communicating uses one or more predefined tones within a first set of frequency bands or a second set of frequency bands.

A device for wireline communications is described. The device may include means for using a set of CO modems at a first distribution point to provide service to a first set of CPE modems over a first set of lines in a binder, wherein the binder further comprises a second set of lines associated with a second set of CPE modems serviced by a second distribution point, means for detecting crosstalk between the first set of lines and the second set of lines, and means for communicating, based at least in part on the detected crosstalk, with the second distribution point over a crosstalk link, wherein the communicating uses one or more predefined tones within a first set of frequency bands or a second set of frequency bands.

Another device for wireline communications is described. The device may include a processor, memory in electronic communication with the processor, and instructions stored in the memory. The instructions may be operable to cause the processor to use a set of CO modems at a first distribution point to provide service to a first set of CPE modems over a first set of lines in a binder, wherein the binder further comprises a second set of lines associated with a second set of CPE modems serviced by a second distribution point, detect crosstalk between the first set of lines and the second set of lines, and communicate, based at least in part on the detected crosstalk, with the second distribution point over a crosstalk link, wherein the communicating uses one or more predefined tones within a first set of frequency bands or a second set of frequency bands.

A non-transitory computer readable medium for wireline communications is described. The non-transitory computer-readable medium may include instructions operable to cause a processor to use a set of CO modems at a first distribution point to provide service to a first set of CPE modems over a first set of lines in a binder, wherein the binder further comprises a second set of lines associated with a second set of CPE modems serviced by a second distribution point, detect crosstalk between the first set of lines and the second set of lines, and communicate, based at least in part on the detected crosstalk, with the second distribution point over a crosstalk link, wherein the communicating uses one or more predefined tones within a first set of frequency bands or a second set of frequency bands.

In some examples of the method, devices, and non-transitory computer-readable medium described above, communicating with the second distribution point comprises: coordinating use of the first set of frequency bands and the second set of frequency bands by the first distribution point and the second distribution point. In some examples of the method, devices, and non-transitory computer-readable medium described above, communicating with the second distribution point comprises: exchanging control and data messages with the second distribution point.

Some examples of the method, devices, and non-transitory computer-readable medium described above may further include processes, features, means, or instructions for determining that the detected crosstalk does not satisfy a threshold. Some examples of the method, devices, and non-transitory computer-readable medium described above may further include processes, features, means, or instructions for operating the set of CO modems and the first set of CPE modems on the first set of lines using one or both of the first set of frequency bands and the second set of frequency bands based at least in part on the determination.

Some examples of the method, devices, and non-transitory computer-readable medium described above may further include processes, features, means, or instructions for receiving, over the crosstalk link, an indication that the second distribution point may be beginning service on the first set of frequency bands or the second set of frequency bands. Some examples of the method, devices, and non-transitory computer-readable medium described above may further include processes, features, means, or instructions for adjusting the operation of the set of CO modems and the first set of CPE modems to refrain from using the first set of frequency bands or the second set of frequency bands based at least in part on the received indication.

Some examples of the method, devices, and non-transitory computer-readable medium described above may further include processes, features, means, or instructions for receiving, over the crosstalk link, a first message, the first message comprising a request to use either the first set of frequency bands or the second set of frequency bands. Some examples of the method, devices, and non-transitory computer-readable medium described above may further include processes, features, means, or instructions for transmitting, over the crosstalk link, a second message, wherein the second message may be from a group consisting of: an acknowledgment of the request to use the first set of frequency bands or the second set of frequency bands and an indication that one of the first set of frequency bands or the second set of frequency bands may be available. Some examples of the method, devices, and non-transitory computer-readable medium described above may further include processes, features, means, or instructions for adjusting the operation of the set of CO modems and the first set of CPE modems to refrain from using the first set of frequency bands or the second set of frequency bands based at least in part on the received request.

In some examples of the method, devices, and non-transitory computer-readable medium described above, the second message comprises a symbol boundary offset, a cyclic extension size, and a synchronization symbol position. Some examples of the method, devices, and non-transitory computer-readable medium described above may further include processes, features, means, or instructions for determining that the detected crosstalk satisfies a threshold. Some examples of the method, devices, and non-transitory computer-readable medium described above may further include processes, features, means, or instructions for transmitting, over the crosstalk link, an indication that service on the first set of frequency bands or the second set of frequency bands may be beginning based at least in part on the determination. Some examples of the method, devices, and non-transitory computer-readable medium described above may further include processes, features, means, or instructions for determining that the detected crosstalk no longer satisfies the threshold. Some examples of the method, devices, and non-transitory computer-readable medium described above may further include processes, features, means, or instructions for operating the set of CO modems and the first set of CPE modems using one or both of the first set of frequency bands or the second set of frequency bands based at least in part on the crosstalk no longer satisfying the threshold.

In some examples of the method, devices, and non-transitory computer-readable medium described above, the indication may be transmitted sequentially by each of the set CO modems or the first set of CPE modems. Some examples of the method, devices, and non-transitory computer-readable medium described above may further include processes, features, means, or instructions for determining that the detected crosstalk satisfies a threshold. Some examples of the method, devices, and non-transitory computer-readable medium described above may further include processes, features, means, or instructions for transmitting, over the crosstalk link, a first message, wherein the first message comprises a request to use the first set of frequency bands or the second set of frequency bands based at least in part on the determination. Some examples of the method, devices, and non-transitory computer-readable medium described above may further include processes, features, means, or instructions for receiving, over the crosstalk link, a second message, wherein the second message may be from a group consisting of: an acknowledgment of the request to use the first set of frequency bands or the second set of frequency bands and an indication that one of the first set of frequency bands or the second set of frequency bands may be available. Some examples of the method, devices, and non-transitory computer-readable medium described above may further include processes, features, means, or instructions for operating the set of CO modems and the first set of CPE modems based at least in part the received second message.

Some examples of the method, devices, and non-transitory computer-readable medium described above may further include processes, features, means, or instructions for detecting synchronization information associated with the second distribution point. Some examples of the method, devices, and non-transitory computer-readable medium described above may further include processes, features, means, or instructions for synchronizing operating parameters for the set of CO modems and the first set of CPE modems based at least in part on the detected synchronization information. In some examples of the method, devices, and non-transitory computer-readable medium described above, the detected synchronization information may be from a group consisting of: a sampling clock and an initial symbol boundary.

Some examples of the method, devices, and non-transitory computer-readable medium described above may further include processes, features, means, or instructions for receiving, on the crosstalk link, vectoring information. Some examples of the method, devices, and non-transitory computer-readable medium described above may further include processes, features, means, or instructions for using the vectoring information to estimate one or more crosstalk coefficients.

Some examples of the method, devices, and non-transitory computer-readable medium described above may further include processes, features, means, or instructions for redefining a set of frequency bands used for communication with the set of CO modems and the first set of CPE modems based at least in part on the crosstalk coefficient estimation. In some examples of the method, devices, and non-transitory computer-readable medium described above, communicating with the second distribution point over the crosstalk link comprises: transmitting a pseudo-random binary sequence on each of the first set of lines.

Some examples of the method, devices, and non-transitory computer-readable medium described above may further include processes, features, means, or instructions for using the set of CO modems and the first set of CPE modems to monitor the one or more predefined tones for one or more values that correspond to a pseudo-random binary sequence. In some examples of the method, devices, and non-transitory computer-readable medium described above, each of the one or more predefined tones may be reserved for use by the first distribution point or the second distribution point.

In some examples of the method, devices, and non-transitory computer-readable medium described above, each of the one or more predefined tones may be shared by the first distribution point or the second distribution point. In some examples of the method, devices, and non-transitory computer-readable medium described above, the first set of frequency bands and the second set of frequency bands may be non-overlapping.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a digital subscriber line (DSL) system with customer premises equipment (CPEs) communicatively coupled to a central office (CO) via a cable binder in accordance with various aspects of the present disclosure;

FIG. 2 illustrates an example of a DSL system with sets of CPEs communicatively coupled to respective COs via a cable binder in accordance with various aspects of the present disclosure;

FIGS. 3A through 3D show state diagrams implemented in a system that supports multi-operator vectoring in DSL modems in accordance with various aspects of the present disclosure;

FIGS. 4A and 4B show block diagrams of devices configured for multi-operator vectoring in DSL modems in accordance with aspects of the present disclosure;

FIG. 5 illustrates an example of a method for multi-operator vectoring in DSL modems in accordance with various aspects of the present disclosure.

### DETAILED DESCRIPTION

The techniques of this disclosure are directed to methods to improve the line rate for multi-operator deployment scenarios, where each operator's distribution points are not physically connected to each other (e.g., by a cable or other direct wireline connection). In some examples, this is achieved by dividing the vectored spectrum among operators to avoid crosstalk from one operator's modems to the other operator's modems. Additionally, a crosstalk link between the modems of one operator and modems of another operator (e.g., a pairing of energy between two or more adjacent lines that changes a signal) is used to act as a channel for synchronizing or exchanging information between the operators.

In one example, the crosstalk link is used by multiple distribution points to coordinate the use of multiple sets of frequency bands. That is, distribution points transmit and receive signals over the crosstalk link to enable sharing of multiple sets of frequency bands. The crosstalk link is used to carry messages between the distribution points, and the message may include information to synchronize the operations of the distribution points. Additionally or alternatively, the crosstalk link is used to transmit data and/or control information between the distribution points. The descriptions herein are generally directed to the case of two operators sharing lines in a cable binder, and can be extended to cases with more operators.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, portions of the methods described may be performed in an order different from that described, and various steps may be added, omitted, or combined. Also, features described with respect to some examples may be combined in other examples.

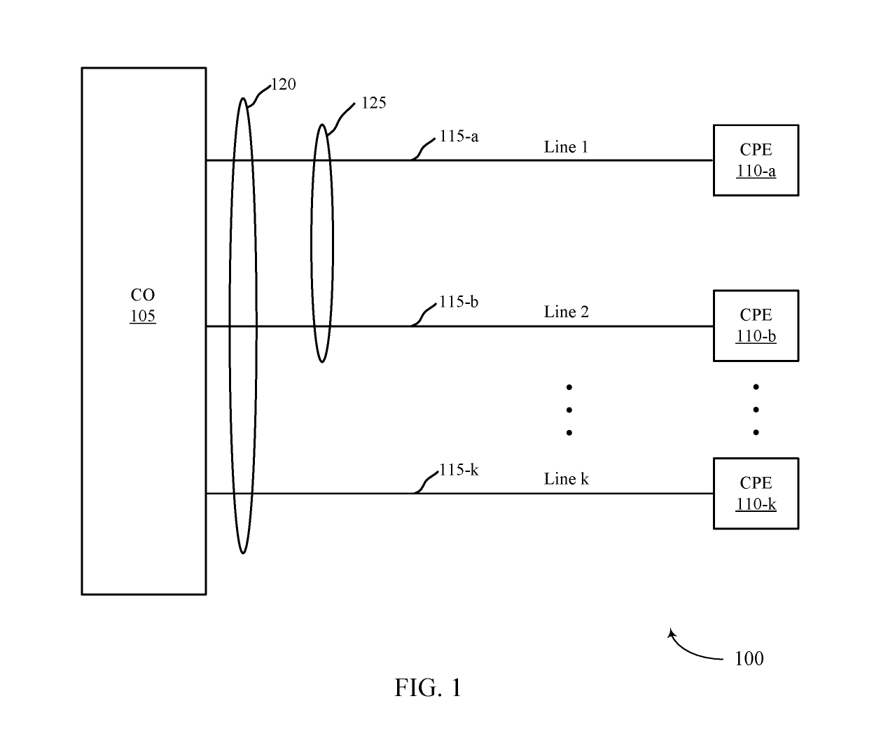

FIG. 1 illustrates an example of a DSL system 100 with CPEs communicatively coupled to a CO via a cable binder in which techniques for multi-operator vectoring in DSL modems is implemented. DSL system 100 includes a CO 105 that is connected to a number of remote nodes, such as consumer premises equipment (CPEs) 110 (e.g., CPEs 110-a through 110-k), via a cable binder 120 comprising one or more sub-binders 125. The CPEs 110 are communicatively coupled to the CO 105 via respective subscriber lines denoted 115-a, 115-b, through 115-k. Each of the lines 115-a, 115-b, and 115-k include, for example, one or more twisted-pair copper wire connections. A given CPE 110 includes a modem, a computing device, or other types of communication devices, or combinations of such devices which are configured to send and receive data to and from CO 105. A CO 105 may also be referred to as a distribution point, and contain further components used for vectoring and the coordination of multiple sets of modems.

Communications between the CO 105 and the CPEs 110 include both downstream and upstream communications for each of the active subscriber lines 115. The downstream direction refers to the direction from CO 105 to CPE 110, and the upstream direction is the direction from CPE 110 to CO 105. Although not explicitly shown in FIG. 1, each of the subscriber lines 115 of DSL system 100 includes a CO transmitter and a CPE receiver for use in communicating in the downstream direction, and a CPE transmitter and a CO receiver for use in communicating in the upstream direction. On both the CO 105 and CPE 110 side, hardware implementing both a transmitter and a receiver is generically referred to as a modem.

Because different subscriber lines 115 are in close proximity with each other in cable binder 120 and sub-binder 125, these subscriber lines 115 can be susceptible to crosstalk interference. Therefore, data signals transmitted on neighboring or close-proximity subscriber lines 115 can be superimposed on and contaminate each other, which is referred to as crosstalk. Based at least in part on such crosstalk, data signals transmitted over subscriber lines 115 can be considerably degraded by the crosstalk interference generated on one or more adjacent subscriber lines 115 in the same and/or nearby multi-core cable or cable binder 120. Accordingly, a transmission on one subscriber line 115 is detected on other subscriber lines 115. To help alleviate the issue of transmitting and receiving data on a subscriber line 115 that has been compromised by crosstalk interference, DSL system 100 uses vectoring to decrease the effects of interference that occurs among multiple subscriber lines 115. That is, vectoring enables coordinated communication between twisted pairs of DSL lines sharing a same cable binder to mitigate crosstalk.

Modems used for communication in DSL system 100 (e.g., discrete multitoned (DMT) modems) are affected by far-end crosstalk (FEXT) between the modems that are connected to subscriber lines 115 in the same cable binder 120. FEXT is greater in higher frequencies and, for example, causes the line rate of a 106 MHz modem in the presence of crosstalk to be as low as 20% of the rate when there is no crosstalk. The International Telecommunication Union (ITU) standard G.vector specifies a method of cancelling the crosstalk between modems, where crosstalk cancellation is done at the CO end of the line. For the downstream direction (e.g., CO 105 to CPE 110), the CO 105 uses modulated tone data on each symbol that is transmitted on each of the lines to compute modified data such that the crosstalk will be cancelled. In the upstream direction (e.g., CPE 110 to CO 105), the CO 105 uses the received tone data on each symbol for each of the lines to cancel the crosstalk.

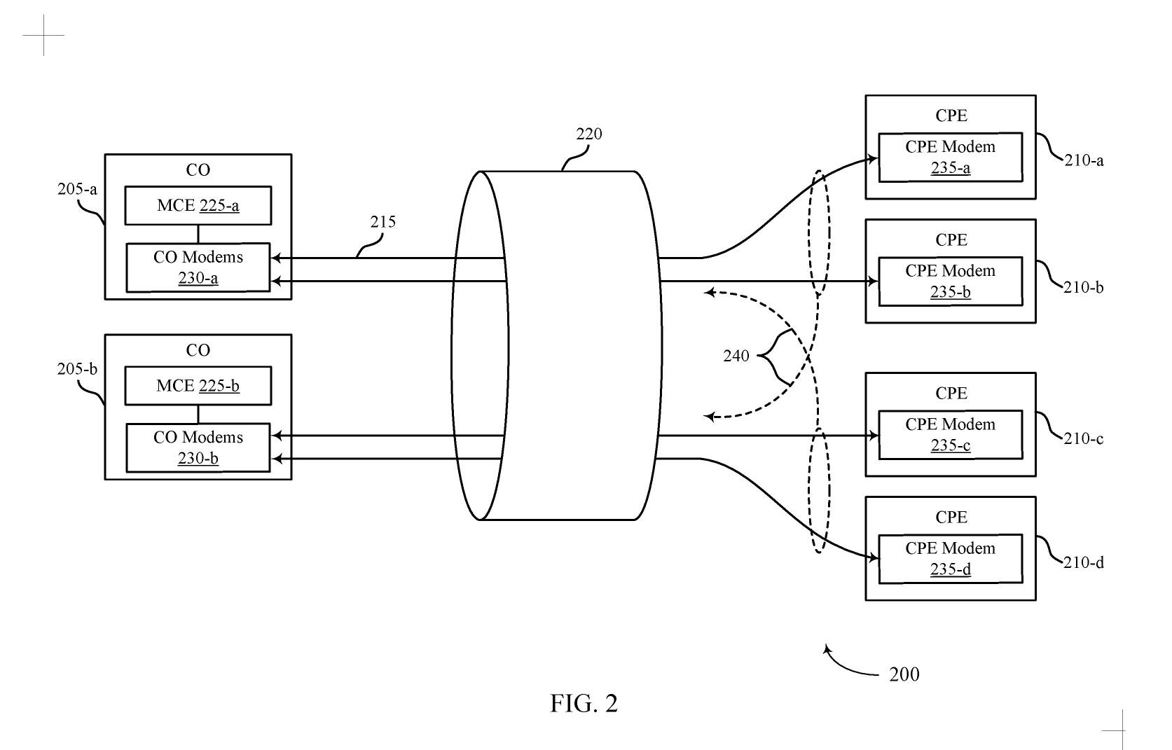

FIG. 2 illustrates an example of a DSL system 200 with sets of CPEs communicatively coupled to respective COs via a cable binder that supports multi-operator vectoring in DSL modems. DSL system 200 includes multiple COs 205 (e.g., a first CO 205-a and a second CO 205-b) that each communicate with a set of CPEs 210 over multiple subscriber lines 215. First CO 205-a communicates with one or more CPEs 210 (e.g., CPE 210-a and CPE 210-b) and second CO 205-b communicates with one or more CPEs 210 (e.g., CPE 210-c and CPE 210-d). In one example, first CO 205-a and second CO 205-b are associated with different operators and do not have a direct connection to each other. In another example, first CO 205-a and second CO 205-b belong to the same operator, but are not physically close enough to have a direct connection between them (e.g., first CO 205-a is located curb-side and second CO 205-b is in a basement, or COs 205 are on different floors of a building, etc.). First CO 205-a and second CO 205-b communicate with CPEs 210 using multiple subscriber lines 215 that share the same cable binder 220. DSL system 200 represents an example of a system that supports coordination by multiple distribution points for the use of different sets of frequency bands. The coordination is achieved through the use of a crosstalk link for the exchange of information, such as indicators and messages.

Each CO 205 includes a multi-operator control entity MCE 225 (e.g., MCE 225-a and MCE 225-b) in communication with a set of CO modems 230. CO modems 230 support multiple subscriber lines and are used to communicate with the CPEs 210 associated with the CO 205, where each CPE 210 includes a CPE modem 235. That is, first CO 205-a includes first MCE 225-a in communication with CO modems 230-a, and second CO 205-b includes second MCE 225-b in communication with CO modems 230-b. Similarly, CPE 210-a includes CPE modem 235-a, CPE 210-b includes CPE modem 235-b, and so forth. MCEs 225 act as a central entity to control the CO modems 230 associated with an operator, and each operator has its own MCE 225 controlling its set of CO modems 230 and CPE modems 235. The MCEs 225 can be separate or combined with a vectoring control entity (VCE) (not shown) that controls a vectoring state machine of that operator's modems in cable binder 220.

In the example given in FIG. 2, the modems represent examples of FDD modems, where a set of frequency bands are used for downstream communication (CO 205 transmits, CPE 210 receives), and a set of frequency bands that are used for upstream communication (CPE 210 transmits, CO 205 receives). An example of an FDD modem is a VDSL2 modem, and another example is an FDD-106 modem that is created by extending a VDSL2 band-plan to cover 106 MHz. It can be assumed that all operators whose modems share frequency bands use the same type of standard, such as VDSL2, FDD-106, etc. It can also be assumed that vectoring is performed within the modems associated with an MCE 225. Thus, all modems associated with an MCE 225 have a same sample clock, symbol boundary, and aligned symbol positions (e.g., synchronization symbols) that are aligned. The modems may also represent examples of time division duplexing (TDD) modems.

In some cases, two operators share the same cable binder 220 and the frequency spectrum is divided into two sets of frequency bands (e.g., set A and set B), with each set having one or more downstream bands and one or more upstream bands. In such cases, modems of a first operator (e.g., CO modems 230-a in communication with CPE modem 235-a and/or CPE modem 235-b) use a first set of frequency bands, and modems of a second operator (e.g., CO modems 230-b in communication with CPE modem 235-c and CPE modem 235-d) use a second set of frequency bands.

A frequency band in a set of frequency bands is chosen to be exclusive to one operator or shared among multiple operators. That is, an exclusive frequency band is a frequency band that is used by the modems of one operator, where only modems of this operator transmit on a given frequency in this frequency band. Crosstalk is accordingly cancelled using vectoring among sets of modems associated with each operator.

In the example of two operators sharing the same cable binder, some modems are allocated to the first set of frequency bands and the remaining modems are allocated to the second set of frequency bands (i.e., from the exclusive frequency bands that are available). The size and number of frequency bands in each set are chosen such that the frequency bands of one set do not overlap with frequency bands of the other set, and the capacity in both sets is approximately the same for the range of loop lengths and noise conditions (such as FM radio transmissions) of the deployment.

Splitting frequency bands between multiple operators is beneficial because crosstalk at higher frequencies is significant. For instance, without vectoring, a line rate (e.g., after a few lines of un-cancelled crosstalk) can be as low as 20% of the line rate when crosstalk is absent. With vectoring, subscriber lines 215 that create crosstalk are cancelled, and the line rate can be 90% (or higher) of the rate when crosstalk is absent. Accordingly, two operators that equally split the capacity of the frequency bands may each achieve 90% of half the possible capacity. That is, each operator achieves 45% (or higher) of the rate when crosstalk is absent.

In some cases, multiple modems use shared frequency bands. That is, at some frequency bands (e.g., at low frequencies), crosstalk is not significant, and rather than divide these frequency bands between multiple operators, different sets of modems use the frequency bands without vectoring. Similarly, in bands where there is dominant external noise (such as a previously-deployed VDSL modem, FM radio transmissions, etc.) multiple sets of modems use the frequency band with external noise rather than divide the frequency bands between the operators. Thus, some subset of frequency bands are used without vectoring by different sets of modems, and the other frequency bands are split among the modems.

The sets of frequency bands assigned to different operators can be fixed or dynamically selected. For example, a fixed set of frequency bands are assigned such that a first operator uses a first set of frequency bands and a second operator uses a second set of frequency bands. However, when there are only modems of one operator active in cable binder 220 (e.g., CO modems 230-a are communicating with CPE modem 235-a and/or CPE modem 235-b, where second CO 205-b and associated CPEs 210 are silent), half the capacity remains unused. Thus, a dynamically selected set of frequency bands allows for optimized spectrum usage. For instance, when only one operator's modems are communicating in the binder, the modems use both a first and second set of frequency bands (i.e., the entire frequency spectrum), and when a second operator's DSL modems start up in cable binder 220, each operator's modems use a single set of frequency bands.

A modem's transmitter can be set to transmit certain patterns that enable detection by another MCE 225. For example, after every N_{mce} symbols, a quiet symbol is transmitted in all, or in a predefined set, of frequency bands and a detecting MCE 225 can look in the predefined set of frequency bands for the periodic quiet symbols. The transmitter of the modems also transmits a pseudo-random binary sequence (PRBS) on a set of tones to be detected by the other MCE's modems.

Modems deployed by both operators detect the presence of modems of the other operator, and use the same or compatible methods to choose the set of frequency bands for their own operation. For instance, before CO modems 230-a starts operation, first MCE 225-a initiates an operation detection process to detect the activity of modems associated with another operator (e.g., CO modems 230-b). The operation detection process is accomplished by activating only the receive path of the subscriber lines 215 associated with first MCE 225-a and detecting crosstalk from another operator's modems. In some cases, MCE 225-a may use all of its associated modems and identify a strongest signal from one of the modems. If first MCE 225-a does not find other active modem(s) in cable binder 220 during its operation detection process, then first MCE 225-a uses both sets of frequency bands. While CO modems 230-a (and CPE modem 235-a and/or CPE modem 235-b) start operation, first MCE 225-a also runs, in parallel, a process to detect another operator's start indicator, (e.g., an indication that another operator will begin service).

First MCE 225-a, during its operator detection process, may find another set of active modems in the cable binder 220 (e.g., CO modems 230-b, CPE modem 235-c, and/or CPE modem 235-d), and identifies a first set of frequency bands that are in use and a second set of frequency bands that are free, and in this case, first MCE 225-a (and its associated modems) communicates using the set of frequency bands that are free. The first MCE 225-a may find both sets of frequency bands are in use by second MCE 225-b, and first MCE 225-a transmits a start indicator, using crosstalk link 240 (e.g., a link that includes a crosstalk signal between predefined tones in the frequency band sets), to second MCE 225-b. The start indicator signals that MCE 225-a intends to start communicating on one of the sets of frequency bands.

When second MCE 225-b detects that first MCE 225-a intends to start communicating, second MCE 225-b signals its modems to drop (e.g., stop communicating on) one set of frequency bands. In such cases, second CO 205-b uses a seamless rate adaptation (SRA)-type procedure to inform the CPEs 210-c and 210-d of new bit tables to be used in transmit and receive directions, and refrain from transmitting on the indicated set of frequency bands. Additionally or alternately, CO 205-b and the associated CPEs 210 use an agreed algorithm to drop the tones of the indicated frequency band set and adjust the tone order table based at least in part on a message sent by CO 205-b. Such a technique speeds up the procedure of stopping communication on a set of frequency bands (e.g., as an entire bit and gain table is not sent). First MCE 225-a then detects that second MCE 225-b has stopped using a frequency band set, and the modems associated with first MCE 225-a subsequently start using the vacated frequency band set.

One method for detecting the crosstalk includes matching the received signal power spectral density (PSD) on upstream and downstream frequency bands to the crosstalk pattern expected from CO modems 230 transmitting using a band-plan of the standard being deployed, such as FDD-106. The standard may specify which frequency bands are used for downstream communications and which frequency bands are used for upstream communications. It can be assumed that both operators use the same transmit PSD if they operate from the same location (such as an apartment building basement), and that they use the same upstream power back-off (UPBO) settings.

While an exact crosstalk coupling may not be known, the signal is anticipated based at least in part on relative signal levels between tones within a frequency band and further taking into account which frequency bands are upstream that have FEXT and which frequency bands are downstream that have near-end crosstalk (NEXT). A noise source that is not a modem, such as an FM radio station, has a different crosstalk pattern.

In some examples, second MCE 225-b indicates to first MCE 225-a (when first MCE 225-a is in operation) over crosstalk link 240 that MCE 225-b intends to start operation by transmitting a predefined operator start indicator. In such cases, second MCE 225-b transmits on a pre-defined set of tones (e.g., start indicator tones). The start indicator tones include a set of tones in one or more of the frequency bands. For instance, a group of adjacent tones in the middle of a frequency band are used, since the tones at the band edges can be affected by side-lobes. A group of such tones are allocated in multiple places over the range of frequencies to guard against interference. The MCEs 225 refrain from using a set of start indicator tones in their normal modem operation and leave these tones quiet (e.g., no signal or very low signal leaked from neighboring tones).

Second MCE 225-b, which intends to start service, transmits bits from a predefined PRBS on these start indicator tones, and transmits the same sequence for the duration of a predefined number of symbol periods. The start indicator includes the PRBS symbols optionally followed by a transmission of another PRBS on the start indicator tones for a second duration of a number of symbol periods. MCE 225-b sends the start indicator transmission on each of its provisioned lines, one at a time. That is, the start indicator may be transmitted on one line for a short duration, the next line for a short duration, and so on. In some cases, the start indicator transmission is sent using one modem at a time, because if the transmission is sent simultaneously on multiple modems, crosstalk may affect communications, thereby making it more difficult for first MCE's modems to detect the signal. An MCE 225 can be both transmitting and receiving at the same time in some message protocols.

First MCE 225-a (that is already in operation) runs a parallel process to detect an operator start indicator over the crosstalk link 240 (i.e., on the start indicator tones). First MCE 225-a may monitor the crosstalk link 240 using CO modems 230 and CPE modems 235 to determine if received values on the messaging tones correspond to the PRBS. That is, first MCE 225-a checks the PRBS to identify whether another MCE 225 is transmitting. The modems of first MCE 225-a may use modem receiver operations, such as symbol boundary and clock timing recovery, to align to symbols of second MCE 225-b, and then demodulate the start indicator tones. The signals on the start indicator tones are checked over a period of multiple symbols to confirm that it is not some other noise. If the start indicator includes a second PRBS over a certain duration, then a transition to the second PRBS is detected to more robustly confirm the presence of the other operator's start indicator.

In some examples, the transmission of a start indicator and operator detection process is similarly used for message exchange between multiple MCEs to allow a fine-grained adjustment of communications to avoid FEXT between different operator's modems. Initially, a receiving MCE 225 may monitor crosstalk link 240 using all of it CO modems 230 and take the best received signal (e.g., the strongest) from one of the modems. Depending on the timing and quality of the response to its transmissions that was sent using one modem at a time, a MCE 225 could identify which modems are most suited for the transmission and reception over the crosstalk link. Any further message exchange may happen using one or more of the identified modems, instead of again trying one modem at a time.

MCEs 225 also exchange messages to enable coordination of frequency band use by using a predefined set of tones. That is, the start indicator transmission and detection techniques are extended to enable message exchange between multiple MCEs over crosstalk link 240. For example, one set of predetermined tones (e.g., messaging tones set 1) is reserved for second MCE 225-b, that is starting operation, to send messages to first MCE 225-a. Another set of messaging tones (e.g., messaging tones set 2) are reserved for first MCE 225-a to send messages to MCE 225-b. The messaging includes a request to start using an identified set of frequency bands between the modems associated with first MCE 225-a. Similarly, the messaging includes an acknowledgment that the request for frequency bands has been received, and a subsequent message that indicates that the request set of frequency bands are free.

Several techniques are used for sending messages on messaging tones. For example, since the communication uses crosstalk link 240 between the modems of each MCE 225, messages are limited to 1 bit repeated over multiple symbols to make the messaging robust. Additionally or alternatively, a predetermined PRBS is transmitted on the messaging tones using a repeated sequence of symbols until another MCE 225 replies with a predetermined PRBS on the messaging tones associated with the other MCE 225. In such cases, both sides continue transmitting on the messaging tones to allow the other side to track timing and symbol boundaries.

Messages between multiple MCEs 225 use predetermined sets of tones (e.g., messaging tones set 1 and messaging tones set 2, in a two operator case). In such cases, a tone numbered k refers to a frequency band corresponding to k*tone spacing of the modem. Such inter-MCE signaling tones can be agreed on in standards body organization or in an industry group including at least the operators deploying DSL systems in the region. Sets of inter-MCE messaging tones are built into firmware of a modem by the modem chip/firmware developers and remain configurable from the CO 205 end.

In one example, once a handshake is exchanged between MCEs 225 over crosstalk link 240, the messaging uses one PRBS, repeated on multiple symbols, to indicate a 0 bit value, and a second PRBS, repeated on multiple symbols, is used to indicate a 1 bit value. The messaging is transmitted using high-level data link control (HDLC) encapsulated bytes. The modems of each operator keep transmitting on the messaging tones, and depending on a quality of the crosstalk received, if the quality can handle a higher bit loading and faster messaging is desired, messages are exchanged to increase bit loading per symbol and/or reduce a number of symbols bits are repeated on.

In some examples, the number of frequency bands can be large if the modems of the two operators are synchronized to a same sampling clock. If there is no synchronization in a deployment, then crosstalk is present between one group of frequency bands to another group of frequency bands at band-edges, and the number of frequency bands are kept relatively small. Thus, synchronization between MCEs 225 reduces or eliminates crosstalk at the band edges, allowing for a larger number of frequency bands for communication, and further allowing fine-grained allocation of frequency bands between operators.

First MCE 225-a and second MCE 225-b can be synchronized, where the MCEs 225 synchronize symbols transmitted on subscriber lines 215. The modems associated with an MCE 225 are synchronized to a sample clock, symbol boundary, synchronization symbol position, etc. In one example, first MCE 225-a modems are in operation (e.g., CO modems 230-a are communicating with CPE modem 235-a and/or CPE modem 235-b), and second MCE 225-b starts up and detects a crosstalk signal on one or more modems. The modems of second MCE 225-b use a received PRBS (transmitted on messaging tones from first MCE 225-a) over crosstalk link 240 to perform synchronization operations, such as clock timing recovery, symbol boundary synchronization, etc. Accordingly, the modems associated with second MCE 225-b adjust a sampling clock and symbol boundary to match the sampling clock and symbol boundary associated with first MCE 225-a.

Transmissions on the messaging tones over crosstalk link 240 may be continuous to enable the modems associated with second MCE 225-b to maintain synchronization to the modems of first MCE 225-a. After an initial handshake, first MCE 225-a sends a synchronizing message over crosstalk link 240 indicating the position of a synchronization symbol relative to a symbol in which a synchronizing message starts. In a similar manner, the position of other special symbols, such as a symbol that starts a training phase, a Hadamard sequence for vector group training, or a symbol that starts a low power mode, etc., are also communicated.

Once multiple MCEs 225 have synchronized operations, a synchronized vector training using messaging over crosstalk link 240 can be done to estimate crosstalk coefficients between modems associated with the same MCE 225, as well as between modems associated with different operators. The crosstalk coefficients are then used to estimate capacity and exchange messages between MCEs 225 to acquire an optimal allocation of frequency bands between the MCEs 225. A frequency band can be allotted exclusively to one MCE 225 or the other, or may be allotted to both MCEs 225 if the crosstalk between the sets of modems in that band is not high.

Modems that use lower frequency bands (e.g., modems based at least in part on a different or older standard, such as a VDSL2 30a profile), may still operate on some of the lines in the binder. An MCE 225 would not check the crosstalk on the frequency bands of the older standard, and instead use higher frequency bands. In some cases, the crosstalk is not strong enough for detection, even with the availability of multiple tones and multiple symbols. Accordingly, each operator may assume that it is the only operator and use the entire frequency spectrum. An inability to detect crosstalk may be acceptable, because with a low level of crosstalk, multiple operator using the entire spectrum achieves better rates than dividing the spectrum among the operators. Further, if a message exchange fails and an MCE 225 is unable to communicate with another MCE 225 after a number of attempts, the MCE 225 uses a fallback action. The fallback action may include enabling each MCE 225 to use its own set of previously agreed set of frequency bands. Alternatively, the fallback action may enable each MCE to use the entire set of frequency bands.

In some examples, an MCE 225 may identify which modem or modems are best suited for transmission and reception of signals over crosstalk link 240 depending on the timing and quality of responses received to a start indicator transmission. Accordingly, further message exchange may take place using one or more of the identified modems.

As described above, the various aspects of the methods described herein with reference to two MCEs 225 can be extended to more than two MCEs. In some DSL deployments, there are more than two operators, each with their own MCE 225. With a relatively small number of MCEs 225, such as four or less, each MCE 225 is assigned a unique identifier (ID) and a predefined set of messaging tones which that MCE 225 transmits on. In such cases, modems listen to the messaging tones of the other MCEs 225 to receive messages over a crosstalk link. The messages have a framing format with a message header containing a destination MCE 225 ID field, and the modems (other than the modems of the operator transmitting the message) decode the message, and the MCE 225 whose ID is in the destination MCE ID field, processes the message.

Additionally or alternatively, one set of messaging tones are retained such that modems of all MCEs 225 use the retained tones to transmit messages (e.g., a common set of messaging tones are shared among multiple MCEs 225). The messages have a framing format with a message header containing a destination MCE ID field and a source MCE 225 field. If a modem from more than one MCE transmits at the same symbol period, there may be a collision. In such cases, the transmitting modem also receives and checks the messaging tones it is transmitting on to detect the collision. In case of a collision, a back-off method, such as an exponential back-off, is used by the modems to retry transmission of the message.

Two sets of messaging tones may be used over a crosstalk link. For instance, a second set of messaging tones are used if a collision is detected in a first set of messaging tones. Alternately, the second set of messaging tones are used for large messages which tolerate long latency (such as per-tone signal-to-noise ratio (SNR) information), while the first set of messaging tones are used for messages requiring low latency.

The methods described herein use a crosstalk coupling between groups of modems of multiple operators to act as a channel for exchanging information between the controllers of sets of modems. The information exchange may also be done by sending messages over an operator's uplink network to a central entity on a separate server (e.g., a cloud network). This central entity can either forward the messages to the controllers of the modem groups, or do additional tasks, such as allocating the spectrum between the groups of modems and their coordination.

In some examples, MCEs 225 exchange information, such as data, control messages, or the like. That is, MCEs 225 may communicate using crosstalk link 240 independent of the coordination of sharing frequency bands. In some cases, management messages from a central network management entity and associated with second CO 205-b are sent to first CO 205-a. Thus, first MCE 225-a sends the management messages over crosstalk link 240 to second MCE 225-b. Second MCE 225-b may also send messages over crosstalk link 240 to first MCE 225-a, which then sends the messages to the central network management entity.

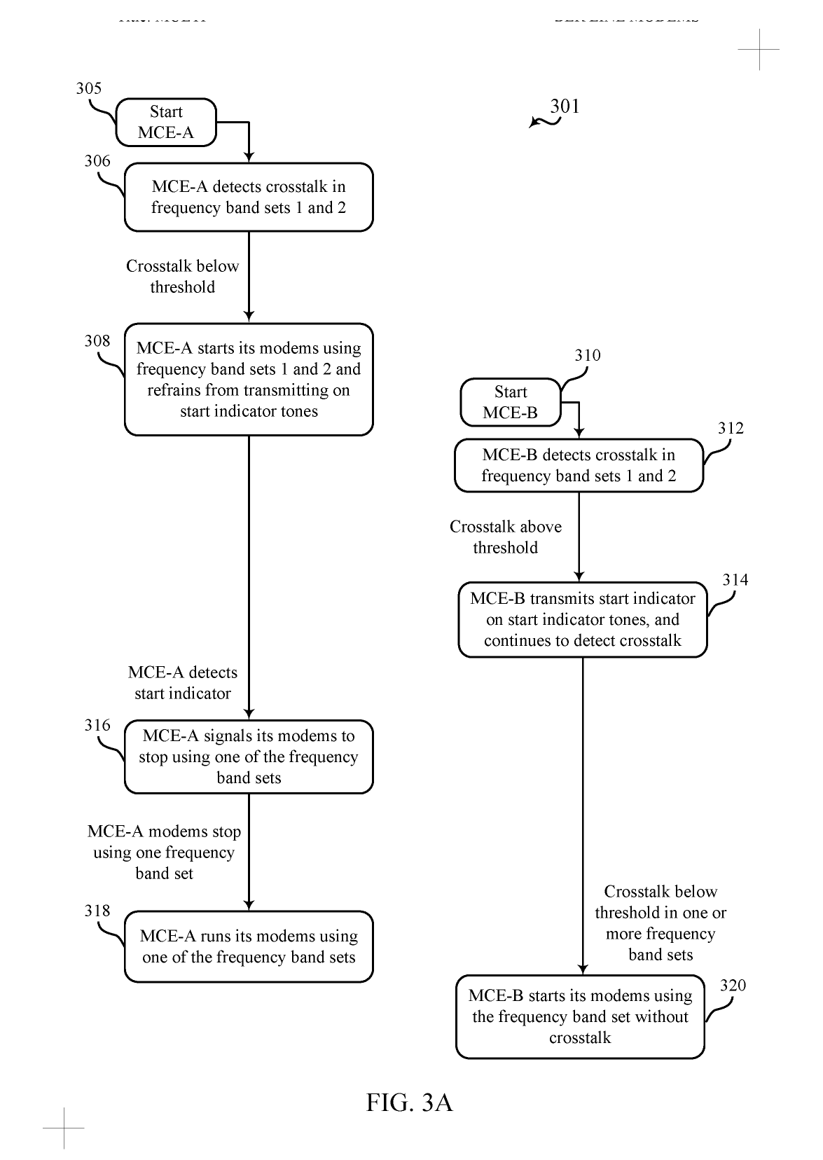

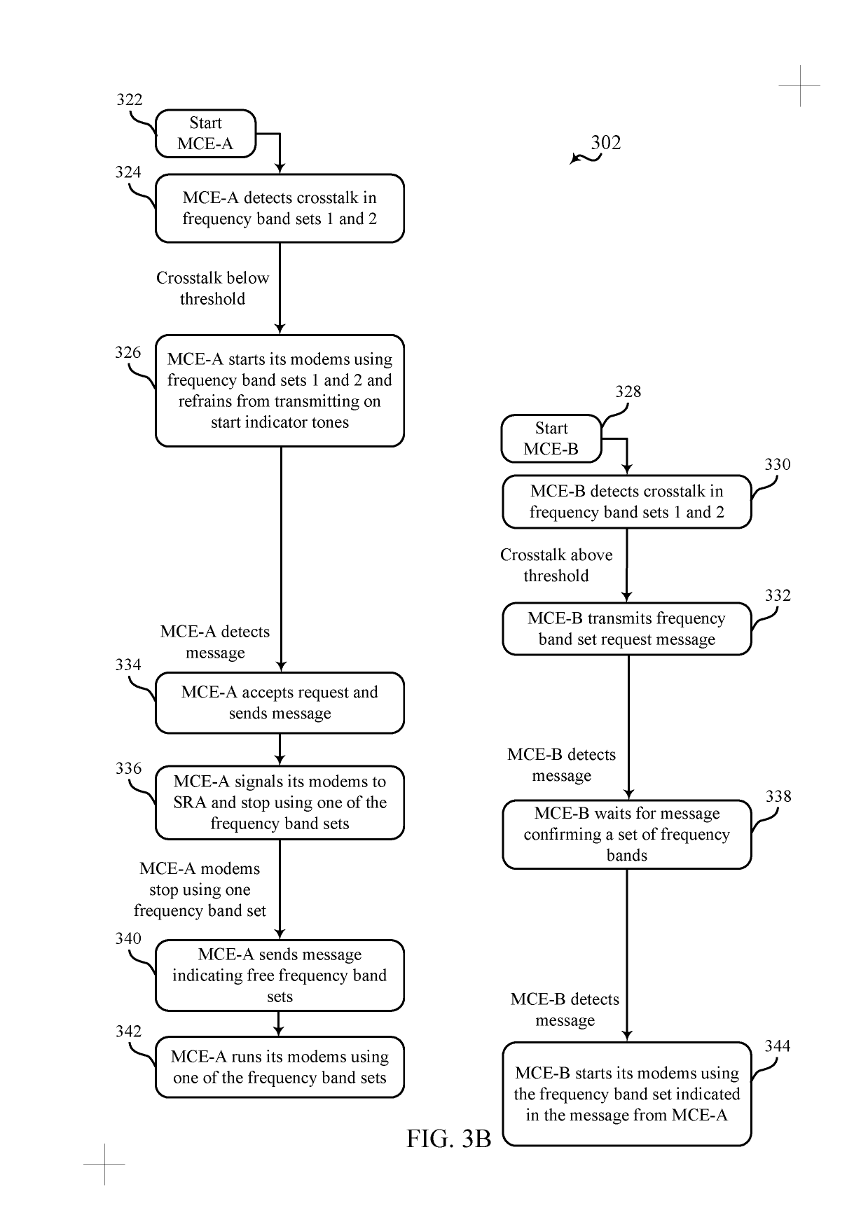

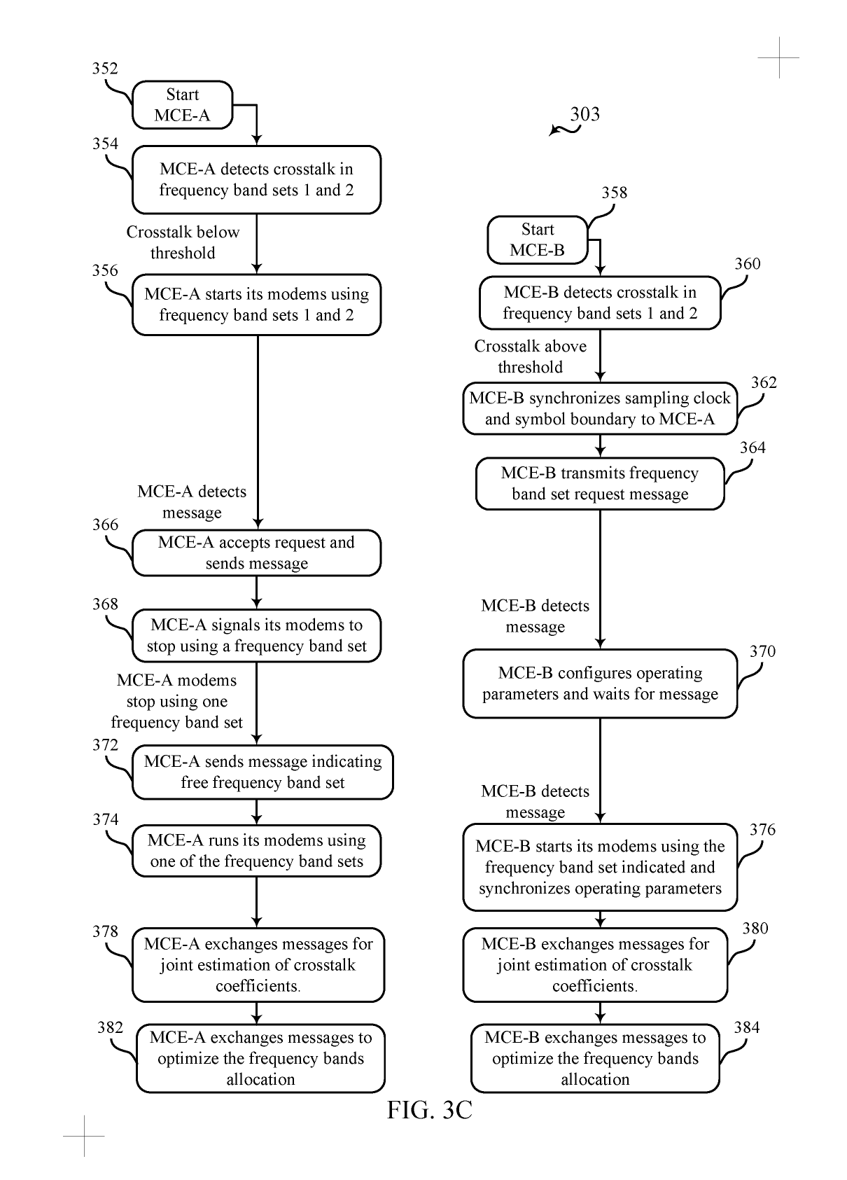

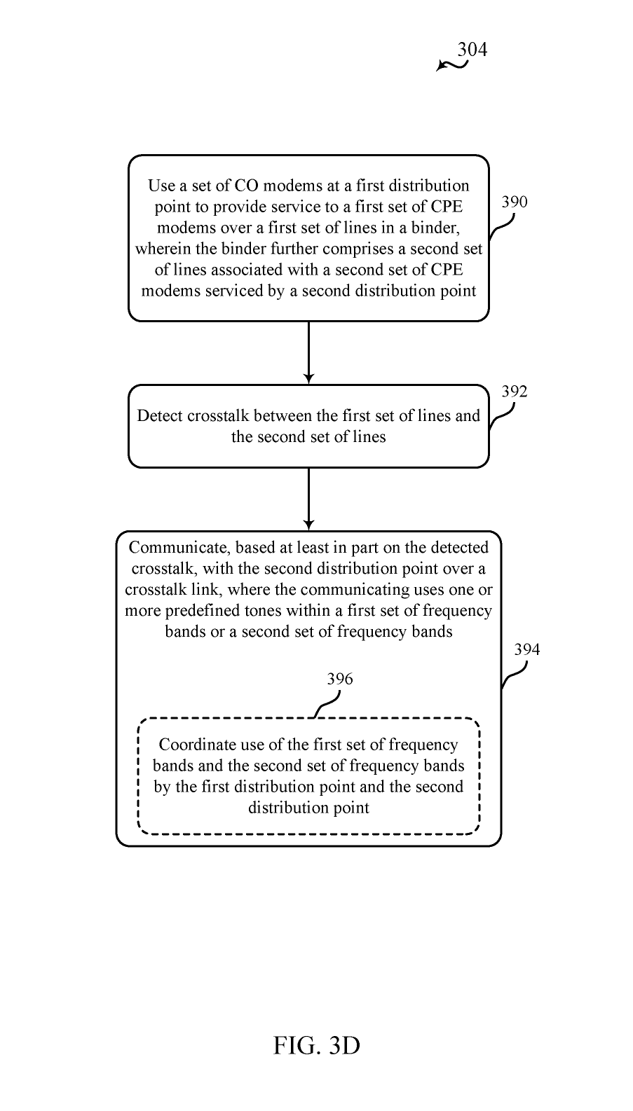

FIGS. 3A through 3D show state diagrams 301 through 304 that illustrate examples of communications between MCEs over a crosstalk link in a system that supports multi-operator vectoring in DSL modems. State diagrams 301 through 304 are implemented in a system that supports multi-operator vectoring in DSL modems in accordance with various aspects of the present disclosure. The techniques described in state diagrams 301 through 304 may be utilized by CO 105, CO 205, CPE 110, CO 205, MCEs 225, CO modems 230, and CPE modems 235 described with reference to FIGS. 1 and 2. In some examples, the techniques described in state diagrams 301 through 304 may be rearranged, performed by other devices and component thereof, and/or otherwise modified such that other implementations are possible. The MCEs described with reference to state diagrams 301 through 304 may be associated with different operators, communicate using subscriber lines that share the same cable binder, and there may be no direct connection between the MCEs (or their associated COs).

In the example of FIG. 3A, state diagram 301 illustrates multiple MCEs using a start indicator transmitted over a crosstalk link to coordinate the use frequency bands. The coordinated use of frequency bands may enable a dynamic selection of frequency bands by multiple MCEs. A first MCE (e.g. MCE-A) starts operation at block 305, and subsequently detects crosstalk in multiple sets of frequency bands (e.g., frequency band set 1 and frequency band set 2) at block 306. Upon determining that the detected crosstalk does not satisfy a threshold (e.g., does not exceed a threshold) in either frequency band set 1 or set 2, at block 308, MCE-A starts a set of modems using both sets of frequency bands and further refrains from transmitting on a predefined set of tones (e.g., start indicator tones).

At block 310, a second MCE (e.g., MCE-B) begins operation and subsequently check frequency band set 1 and frequency band set 2 for the presence of crosstalk at block 312. MCE-B detects that the crosstalk satisfies a threshold (e.g., exceeds a threshold), due to communication by MCE-A, and at block 314 transmits a start indicator using a crosstalk link. The start indicator enables MCE-B to indicate its presence to MCE-A, and the start indicator is transmitted on a set of start indicator tones. In some cases, the start indicator may include a 1-bit message. Following the transmission of the start indicator, the second MCE continues to detect crosstalk in the frequency band sets.

At block 316, MCE-A detects the start indicator transmitted by MCE-B and accordingly signals to the set of modems to stop using one of the sets of frequency bands (e.g., frequency band set 2). The modems associated with MCE-A subsequently stop using frequency band set 2, and at block 318, MCE-A operates the set of modems using frequency band set 1. MCE-B detects that crosstalk in frequency band set 1 no longer satisfies a threshold, and at block 320 starts a set of modems associated with MCE-B to begin communicating using frequency band set 2.

In the example of FIG. 3B, state diagram 302 illustrates multiple MCEs using messaging tones over a crosstalk link to coordinate the use of frequency bands. That is, multiple MCEs may communicate using multiple messages transmitted over messaging tones of a crosstalk link. At block 322, MCE-A starts operation, and at block 324 MCE-A detects crosstalk in frequency band sets 1 and 2. MCE-A determines that the crosstalk in both frequency band sets 1 and 2 does not satisfy a threshold and starts a set of modems using both frequency band sets at block 326.

At block 328, MCE-B starts operation and detects crosstalk in frequency band sets 1 and 2 at block 330. Upon determining that the crosstalk satisfies a threshold, at block 332 MCE-B transmits a message requesting a set of frequency bands for communication (e.g., frequency band set 2). The message is transmitted using a first set of messaging tones over a crosstalk link, where the first set of messaging tones are assigned to MCE-B for communicating. Additionally or alternatively, the first set of messaging tones may be reserved for communication in a certain direction, while a second set of messaging tones are reserved for communication in another direction.

MCE-A detects the message sent by MCE-B over the crosstalk link, and at block 334 MCE-A sends a reply message accepting the request. The reply message to MCE-B is transmitted on the second set of messaging tones assigned to MCE-A for communication over the crosstalk link. At block 336, MCE-A subsequently signals to it set of modems to stop using frequency band set 2 based at least in part on the request received from MCE-B. MCE-A uses an SRA-like procedure that includes new bit tables to be used in transmit and receive directions, and signal to the modems associated with MCE-A to refrain from transmitting on the indicated set of frequency bands.

At block 338, MCE-B detects the reply message from MCE-A over the crosstalk link and awaits a subsequent message confirming that frequency band set 2 is free. Accordingly, after the modems associated with MCE-A stop using frequency band set 2, at block 340 MCE-A transmits a message over the second set of predefined messaging tones of crosstalk link indicating that frequency band set 2 is free. At block 342, the set of modems associated with MCE-A are operated using frequency band set 1. After MCE-B detects the message sent from MCE-A that indicates frequency band set 2 is free, modems associated with MCE-B use frequency band set 2 for communications at block 344. In some examples, the frequency band set used by the modems associated with MCE-B at block 344 depends on the exchanged messages with MCE-A, absence of crosstalk on a frequency band set, or both.

In the example of FIG. 3C, state diagram 303 illustrates multiple MCEs using messaging tones over a crosstalk link to coordinate the use of frequency bands and perform synchronization operations. Further, the synchronized MCEs may use a crosstalk link for the exchange of messages for joint estimation of crosstalk coefficients and synchronize vectoring related training. In some cases, the crosstalk link is used to optimize frequency band allocations.

At block 352 MCE-A starts operation and subsequently detects crosstalk in frequency band sets 1 and 2 at block 354. MCE-A determines that crosstalk in both frequency band set 1 and frequency band set 2 does not satisfy a threshold and controls a set of modems to start communicating in both frequency band sets at block 356. MCE-B may also start operation at block 358 and similarly detect crosstalk in frequency band sets 1 and 2 at block 360.

MCE-B uses its modems to detect a sampling clock and initial symbol boundary of the set of modems associated with MCE-A. One or more messaging tones can be used to transmit a fixed, and known, constellation point continuously on a crosstalk link (e.g., as dedicated pilot tones) to simplify clock acquisition and tracking. At block 362, MCE-B may then synchronize a sampling clock and symbol boundary to a sampling clock and symbol boundary used by MCE-A. MCE-B continues tracking (i.e., adjusting to continually match) the sample clock. MCE-B subsequently transmit a frequency band request message over the crosstalk link at block 364 requesting use of a frequency band set (e.g., frequency band set 2).

Upon detecting the frequency band request message over the crosstalk link, MCE-A accepts the request from MCE-B and transmits a reply message using the crosstalk link at block 366. In some cases, the reply message includes operating parameter associated with MCE-A. The operating parameters may include a symbol boundary offset, a cyclic extension size, and a synchronization symbol position. The symbol boundary includes an amount by which MCE-B adjusts (e.g., by delaying or advancing) a symbol boundary based at least in part on a symbol boundary measured by the modems associated with MCE-A. The cyclic extension size is estimated by MCE-B and communicated by MCE-A to ensure the correct cyclic extension size is used by MCE-B. The synchronization symbol position may be given in terms of an offset to a current symbol. MCE-A transmits a special pattern on the messaging tones during the synchronization symbol. At block 368, MCE-A subsequently signals to its modems to stop using frequency band set 2, based at least in part on the received request message. MCE-B detects the reply message and at block 370 proceeds to configure operating parameters.

The modems associated with MCE-A stop using frequency band set 2, and MCE-A transmits a message over the crosstalk link at block 372, the message indicating that frequency band set 2 is free. MCE-A subsequently operates the set of modems using frequency band set 1 at block 374. MCE-B detects the message that indicates that frequency band set 2 is available, and at block 376 subsequently starts a set of modems associated with MCE-B using frequency band set 2 and synchronizes to the parameters indicated in the message received from MCE-A. As mentioned above, the frequency band set used by the modems associated with MCE-B at block 376 may depend on the exchanged messages with MCE-A, absence of crosstalk on a frequency band set, or both. MCE-B starts using frequency band set 2 with operating parameters matching those of MCE-A, which allows vector training to be done at a later time. In some examples, if no response to a transmitted message is received, then an MCE may start to operate (or continue to operate) its modems using one or both sets of frequency bands.

At blocks 378 and 380, both MCE-A and MCE-B exchange message over messaging tones of the crosstalk link. The messages include information used for coordinated joint estimation of crosstalk coefficients. The estimation can be done on the synchronization symbols using known vectoring methods. The information used may include a current superframe number, a number of modems active for each MCE, Hadamard sequences to be used by each MCE, a symbol at which the Hadamard sequence starts, error information (e.g., error information on the synchronization symbol detected by CPE modems of MCE-A and sent to MCE-B based at least in part on an algorithm), crosstalk coefficients (e.g., crosstalk coefficients determined by one MCE and sent to the other MCE), and an average number of bits loaded per tone for an MCE's modems in each frequency band. Additional messages transmitted over the crosstalk link include detailed bit loading per tone.

The transmission of a synchronization symbol over the crosstalk link is used to synchronize a current superframe number for both MCE-A and MCE-A. A superframe is a fixed number of symbols with a specific position for a synchronization symbol (e.g., a symbol with a pre-defined values transmitted on its tones). Operations in all modems (e.g., the sets of modems associated with MCE-A and MCE-b) may thus start at the same symbol. A synchronized superframe number allows later messages transmitted over the crosstalk link to indicate a synchronization symbol of a particular superframe (given by the superframe number) as the symbol at which an operation happens. Another symbol number may be indicated as the symbol within a superframe at which an operation happens (i.e., instead of the synchronization symbol).

Following joint crosstalk coefficient estimation, the extent of a crosstalk coupling is known from the crosstalk coefficients estimated. At block 382 and 384, MCE-A and MCE-B may cooperatively exchange messages to optimize an allocation of frequency bands, where the allocation of frequency band shared among the modems of each MCE is determined (e.g., an allocation different than fixed frequency bands). In one example, frequency bands, and their usage, are redefined by the MCEs. That is, based at least in part on an average bit loading in the frequency bands of the two MCEs, the frequency bands used by each MCE is redefined. For example, MCE-A has subscriber lines with longer loop lengths than subscriber lines of MCE-B (e.g., MCE-A is deployed from a curb while MCE-B is deployed from within a building). In such cases, MCE-A uses relatively more lower frequency tones than MCE-B.

A frequency band may be used by modems of multiple MCEs if crosstalk in that frequency band not high. A subset of modems associated with an MCE share frequency bands with the modems of another MCE. In one example, MCE-A controls eight modems and MCE-B controls four modems, and two of the modems controlled by MCE-a create crosstalk on a number of the subscriber lines used by the modems of MCE-B. However, the crosstalk does not satisfy a threshold, and the subset of two modems associated with MCE-A can use (share) the frequency band allotted to MCE-B. The threshold used to determine frequency band sharing is represented in terms of an SNR lost due to crosstalk being below certain value.

As a further example, in the frequency band used by the modems of MCE-B, the 4 modems of MCE-B can achieve an average bit loading of 12 bits per tone and the subset of 2 modems associated with MCE-A can achieve an average bit loading of 10 bits per tone. Additionally, crosstalk from the subset of 2 modems sharing the frequency band causes a bit loading reduction of 2 bits on 3 of the modems associated with MCE-B, and a bit loading reduction of 3 bits on the 2 modems in the subset of MCE-A modems. Thus, without sharing, the frequency band carries 12 bits per tone for the 4 modems associated with MCE-B, giving an overall throughput of (12*4)=48 bits per tone. However, with sharing, the frequency band carries 12 bits per tone for 1 modems associated with MCE-B and 12−2=10 bits per tone for the other three modems of MCE-B, in addition to carrying 10−3=7 bits per tone for the subset of 2 modems, giving an overall throughput of 12+(3*10)+(2*7)=56 bits per tone. In such cases, MCE-A sends a message requesting this frequency band be shared for the subset of 2 modems. MCE-B, which owns the frequency band, allows MCE-A to share the requested frequency band, and MCE-A starts using the frequency band for only the subset of 2 modems. MCE-B may also refuse to share the frequency band, in which case MCE-A does not use this band. That is, MCE-B may be configured or programmed with different sharing thresholds, or some of the affected modems associated with MCE-B (e.g., even by 2 bits per tone) fall below a service rate threshold (such as 100 Mbps) paid for by a customer.

In the example of FIG. 3D, state diagram 304 illustrates communication between multiple distribution points over a crosstalk link in a system that supports multi-operator vectoring in DSL modems. At block 390 a device, such as a CO or an MCE, uses a set of CO modems at a first distribution point to provide service to a first set of CPE modems over a first set of lines in a binder, where the binder further includes a second set of lines associated with a second set of CPE modems serviced by a second distribution point.

At block 392, the device detects crosstalk between the first set of lines and the second set of lines and, at block 394, communicates, based at least in part on the detected crosstalk, with the second distribution point over a crosstalk link, where the communicating uses one or more predefined tones within a first set of frequency bands or a second set of frequency bands. At block 396, communicating with the second distribution point may include coordinating use of the first set of frequency bands and the second set of frequency bands by the first distribution point and the second distribution point.

The techniques described in state diagrams 301 through 304 may be rearranged, performed by other devices and component thereof, and/or otherwise modified such that other implementations are possible.

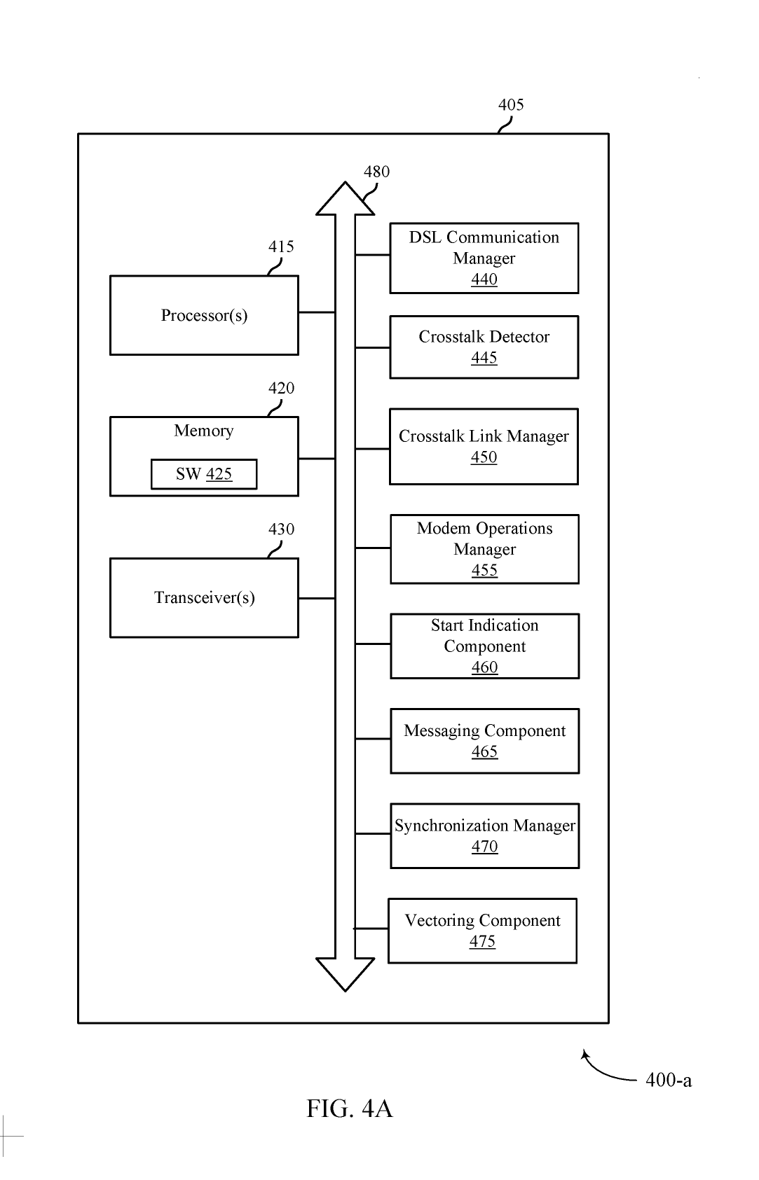

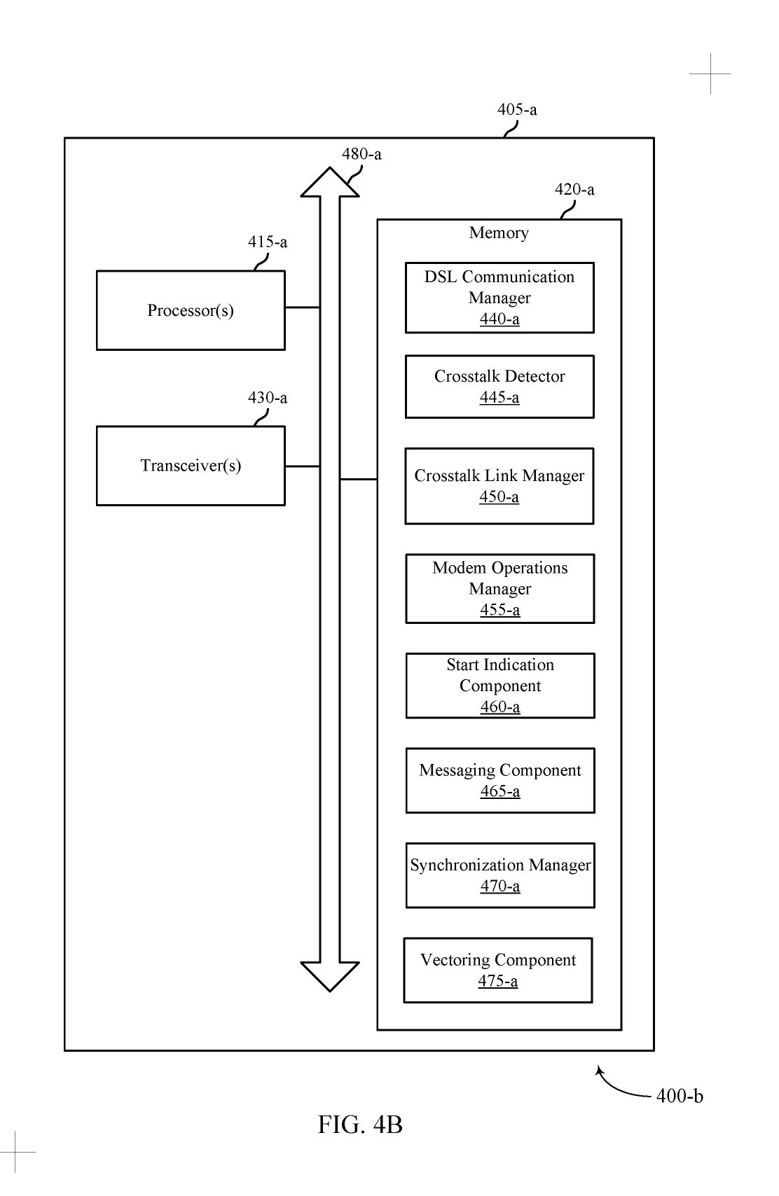

FIG. 4A shows a block diagram 400-a of an example of a device 405 configured for multi-operator vectoring in accordance with various aspects of the present disclosure. The device 405 includes at least one processor 415, memory 420, one or more transceivers 430, a DSL communication manager 440, a crosstalk detector 445, a crosstalk link manager 450, a modem operations manager 455, a start indication component 460, a messaging component 465, a synchronization manager 470, and a vectoring component 475. The processor 415, memory 420, the one or more transceivers 430, the DSL communication manager 440, the crosstalk detector 445, the crosstalk link manager 450, the modem operations manager 455, the start indication component 460, the messaging component 465, the synchronization manager 470, and the vectoring component 475 are communicatively coupled with a bus 480, which enables communication between these components.

The processor(s) 415 is an intelligent hardware device, such as a central processing unit (CPU), a microcontroller, an application-specific integrated circuit (ASIC), etc. The memory 420 stores computer-readable, computer-executable software (SW) code 425 containing instructions that, when executed, cause the processor(s) 415 or another one of the components of the device 405-a to perform various functions described herein, for example, to communication with distribution points over a crosstalk link for exchanging information and/or coordinating use of multiple sets of frequency bands.

The DSL communication manager 440, the crosstalk detector 445, the crosstalk link manager 450, the modem operations manager 455, the start indication component 460, the messaging component 465, the synchronization manager 470, and the vectoring component 475 implement the features described with reference to FIGS. 1 through 3, as further explained below. Further, the DSL communication manager 440, the crosstalk detector 445, the crosstalk link manager 450, the modem operations manager 455, the start indication component 460, the messaging component 465, the synchronization manager 470, and the vectoring component 475 may cooperate to implement any of the state diagrams described with reference to FIGS. 3A through 3D.

Again, FIG. 4A shows only one possible implementation of a device executing the features described herein. While the components of FIG. 4A are shown as discrete hardware blocks (e.g., ASICs, field programmable gate arrays (FPGAs), semi-custom integrated circuits, etc.) for purposes of clarity, it will be understood that each of the components may also be implemented by multiple hardware blocks adapted to execute some or all of the applicable features in hardware. Additionally or alternatively, features of two or more of the components of FIG. 4A may be implemented by a single, consolidated hardware block. For example, a single transceiver 430 chip or the like may implement the processor 415 the DSL communication manager 440, the crosstalk detector 445, the crosstalk link manager 450, the modem operations manager 455, the start indication component 460, the messaging component 465, the synchronization manager 470, and the vectoring component 475.

In still other examples, the features of each component may be implemented, in whole or in part, with instructions embodied in a memory, formatted to be executed by one or more general or application-specific processors. For example, FIG. 4B shows a block diagram 400-b of another example of a device 405-a in which the features of a DSL communication manager 440-a, a crosstalk detector 445-a, a crosstalk link manager 450-a, a modem operations manager 455-a, a start indication component 460-a, a messaging component 465-a, a synchronization manager 470-a, and a vectoring component 475-a are implemented as computer-readable code stored in memory 420-a and executed by one or more processors 415-a. Other combinations of hardware/software may be used to perform the features of one or more of the components of FIGS. 4A and 4B.

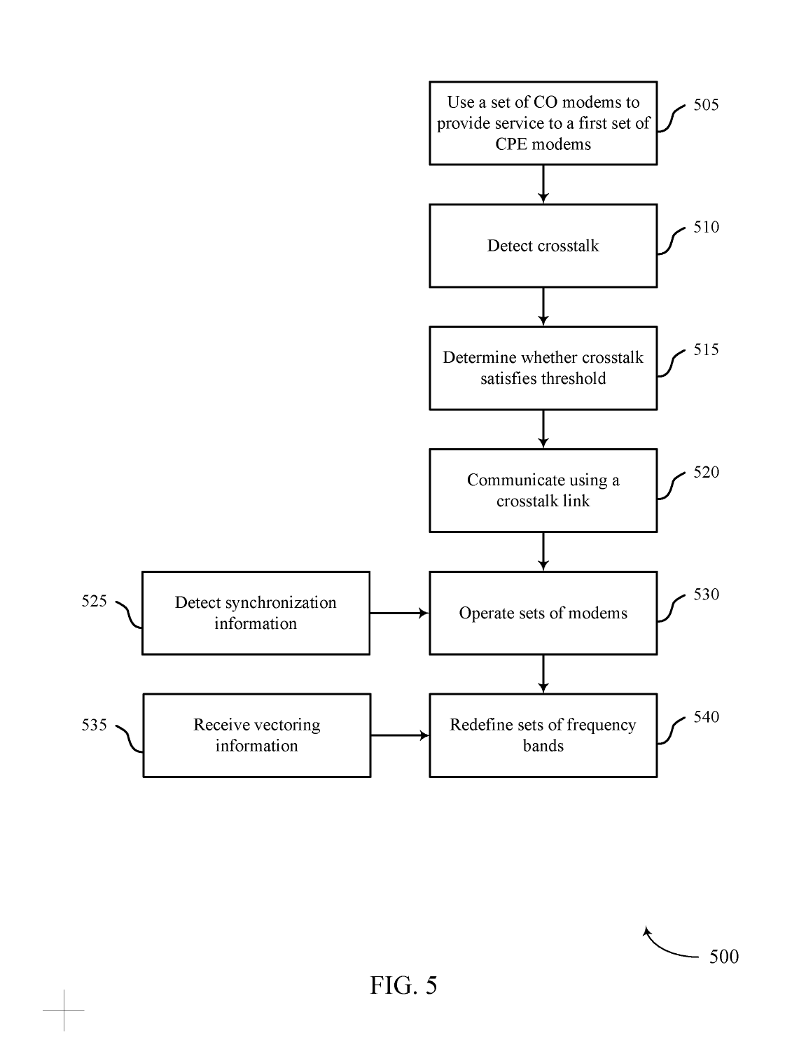

FIG. 5 shows a flow chart that illustrates an example of a method 500 of vectoring a multi-operator vectoring in DSL modems in accordance with various aspects of the present disclosure. The method 500 may be performed by any of the devices discussed in the present disclosure, but for clarity the method 500 will be described from the perspective of device 405-a of FIG. 4A. It is to be understood that the method 500 is just one example of techniques of improving vectoring coefficient determination in a DSL system, and the operations of the method 500 may be rearranged, performed by other devices and component thereof, and/or otherwise modified such that other implementations are possible.

Broadly speaking, the method 500 illustrates a procedure by which the device 405-a communicates using a crosstalk link to exchange information with a distribution point or coordinate use of multiple sets of frequency bands. The method 500 uses sets of modems to detect crosstalk between sets of lines sharing the same cable binder, transmit and receive indications and messages on the crosstalk link based at least in part on the detected crosstalk, and operates the sets of modems based at least in part on messages that are transmitted and received. The method 500 further uses the crosstalk link for the exchange of information, such as control and data messages.

At block 505, the device 405-a uses a set of CO modems at a first distribution point to provide service to a first set of CPE modems. The service is provided over a first set of lines in a binder, where the binder includes a second set of lines that are associated with a second distribution point. In some cases, sets of modems are used by the DSL communication manager 440, which may be an example of an MCE, such as an MCE 225 described with reference to FIG. 2.

At block 510, the crosstalk detector 445 of the device 405-a detects crosstalk between the first and second set of lines in the binder. At block 515 the crosstalk detector 445 determines whether the detected crosstalk satisfies a threshold. For instance, the crosstalk detector 445 determines that the crosstalk does not satisfy a threshold, and the device 405-a may operate a set of modems on multiple sets of frequency bands based at least in part on the determination. Additionally or alternatively, the crosstalk detector detects that the crosstalk satisfies a threshold, and the device 405-a may further use a crosstalk link to exchange messages with a second distribution point before using a set of frequency bands.

At block 520, the crosstalk link manager 450 of the device 405-a communicates with the second distribution point over a crosstalk link using one or more predefined tones. In some examples the communication includes coordinating use of a first and second set of frequency bands. In other examples, the crosstalk link manager 450 exchanges information, such as control and data messages, using the crosstalk link. The crosstalk link manager 450 may facilitate communication over the crosstalk link using transceivers 430 of device 405-a.

The coordination between the first distribution point and the second distribution point for use of the first and second sets of frequency bands may include the exchange of indicators or messages on the one or more predefined tones. For instance, the start indication component 460 of device 405-a transmits and receives indications that service is beginning on the first or the second set of frequency bands. Similarly, messaging component 465 of device 405-a transmits and receives messages that indicate a set of frequency bands that a distribution point intends to use, as well as messages indicating that a set of frequency bands are free.

At block 525, the synchronization manager 470 of device 405-a detects synchronization information associated with the second distribution point, and further synchronizes operating parameters for the set of CO modems and the first set of CPE modems based at least in part on the detected synchronization information. The synchronization information is transmitted over the crosstalk link and communicated to the synchronization manager 470 by the transceivers 430 or by the crosstalk link manager 450.

At block 530, the modem operations manager 455 of device 405-a operates the set of CO modems and the first set of CPE modems. The operation of the modems is based at least in part on the detected crosstalk or received messages and indicators received over the crosstalk link. For instance, crosstalk detector 445 determines that the crosstalk is below a threshold and the modem operations manager 455 operates the modems using one or both of the first and second sets of frequency bands. In other examples, start indication component 460 or messaging component 465 receive an indication or message, and the modem operations manager adjusts operation of the CO modems and the first set of CPE modems based at least in part on the message. The operation of the modems can include exchange of messages to co-ordinate on the crosstalk link and perform a vectoring system training together on all the modems of both the distribution points.

At block 535 vectoring component 475 of device 405-a receives, on the crosstalk link, vectoring training information and uses the vectoring training information to estimate one or more crosstalk coefficients. The crosstalk coefficients are then used to estimate capacity and exchange messages between distribution points to acquire an optimal allocation of frequency bands. Accordingly, at block 540, the modem operations manager 455 redefines a set of frequency bands used for communication with the CO modems and the first set of CPE modems.

It is to be appreciated that, in some cases, different vectored signals are generated for different victim-disturber pairs and set of tones. As such, the method 500 shown in FIG. 5 is for the sake of simplicity and illustration, and is not intended to be exhaustive of permutations that can be envisioned for practical implementations of DSL vectoring.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these.

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C., as well as any combination with multiples of the same element (e.g., A-A, A-A-A, A-A-B, A-A-C, A-B-B, A-C-C, B-B, B-B-B, B-B-C, C-C, and C-C-C or any other ordering of A, B, and C).

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireline communications, comprising:
using a set of central office (CO) modems at a first distribution point to provide service to a first set of consumer premises equipment (CPE) modems over a first set of lines in a binder, wherein the binder further comprises a second set of lines associated with a second set of CPE modems serviced by a second distribution point;
detecting crosstalk between the first set of lines and the second set of lines; and
communicating, based at least in part on the detected crosstalk, with the second distribution point over a crosstalk link, wherein the communicating uses one or more predefined tones within a first set of frequency bands or a second set of frequency bands.

2. The method of claim 1, wherein communicating with the second distribution point comprises:
coordinating use of the first set of frequency bands and the second set of frequency bands by the first distribution point and the second distribution point.

3. The method of claim 1, wherein communicating with the second distribution point comprises:
exchanging control and data messages with the second distribution point.

4. The method of claim 1, further comprising:
determining that the detected crosstalk does not satisfy a threshold; and
operating the set of CO modems and the first set of CPE modems on the first set of lines using one or both of the first set of frequency bands and the second set of frequency bands based at least in part on the determination.

5. The method of claim 4, further comprising:
receiving, over the crosstalk link, an indication that the second distribution point is beginning service on the first set of frequency bands or the second set of frequency bands; and
adjusting the operation of the set of CO modems and the first set of CPE modems to refrain from using the first set of frequency bands or the second set of frequency bands based at least in part on the received indication.

6. The method of claim 4, further comprising:
receiving, over the crosstalk link, a first message, the first message comprising a request to use either the first set of frequency bands or the second set of frequency bands;
transmitting, over the crosstalk link, a second message, wherein the second message is from a group consisting of: an acknowledgment of the request to use the first set of frequency bands or the second set of frequency bands and an indication that one of the first set of frequency bands or the second set of frequency bands are available; and
adjusting the operation of the set of CO modems and the first set of CPE modems to refrain from using the first set of frequency bands or the second set of frequency bands based at least in part on the received request.

7. The method of claim 6, wherein the second message comprises a symbol boundary offset, a cyclic extension size, and a synchronization symbol position.

8. The method of claim 1, further comprising:
determining that the detected crosstalk satisfies a threshold;
transmitting, over the crosstalk link, an indication that service on the first set of frequency bands or the second set of frequency bands is beginning based at least in part on the determination;
determining that the detected crosstalk no longer satisfies the threshold; and
operating the set of CO modems and the first set of CPE modems using one or both of the first set of frequency bands or the second set of frequency bands based at least in part on the crosstalk no longer satisfying the threshold.

9. The method of claim 8, wherein the indication is transmitted sequentially by each of the set of CO modems or the first set of CPE modems.

10. The method of claim 1, further comprising:
determining that the detected crosstalk satisfies a threshold;
transmitting, over the crosstalk link, a first message, wherein the first message comprises a request to use the first set of frequency bands or the second set of frequency bands based at least in part on the determination;
receiving, over the crosstalk link, a second message, wherein the second message is from a group consisting of: an acknowledgment of the request to use the first set of frequency bands or the second set of frequency bands and an indication that one of the first set of frequency bands or the second set of frequency bands are available; and
operating the set of CO modems and the first set of CPE modems based at least in part the received second message.

11. The method of claim 10, further comprising:
detecting synchronization information associated with the second distribution point; and
synchronizing operating parameters for the set of CO modems and the first set of CPE modems based at least in part on the detected synchronization information.

12. The method of claim 11, wherein the detected synchronization information is from a group consisting of: a sampling clock and an initial symbol boundary.

13. The method of claim 1, further comprising:
receiving, on the crosstalk link, vectoring information; and
using the vectoring information to estimate one or more crosstalk coefficients.

14. The method of claim 13, further comprising:
redefining a set of frequency bands used for communication with the set of CO modems and the first set of CPE modems based at least in part on the crosstalk coefficient estimation.

15. The method of claim 1, wherein communicating with the second distribution point over the crosstalk link comprises:
transmitting a pseudo-random binary sequence on each of the first set of lines.

16. The method of claim 1, further comprising:
using the set of CO modems and the first set of CPE modems to monitor the one or more predefined tones for one or more values that correspond to a pseudo-random binary sequence.

17. The method of claim 1, wherein each of the one or more predefined tones are reserved for use by the first distribution point or the second distribution point.

18. The method of claim 1, wherein each of the one or more predefined tones are shared by the first distribution point or the second distribution point.

19. The method of claim 1, wherein the first set of frequency bands and the second set of frequency bands are non-overlapping.

20. A communication device for wireline communications, comprising:
means for using a set of central office (CO) modems at a first distribution point to provide service to a first set of consumer premises equipment (CPE) modems over a first set of lines in a binder, wherein the binder further comprises a second set of lines associated with a second set of CPE modems serviced by a second distribution point;
means for detecting crosstalk between the first set of lines and the second set of lines; and
means for communicating, based at least in part on the detected crosstalk, with the second distribution point over a crosstalk link, wherein the communicating uses one or more predefined tones within a first set of frequency bands or a second set of frequency bands.

21. A communication device for wireline communications, in a system comprising:
a processor;
memory in electronic communication with the processor; and
instructions stored in the memory and operable, when executed by the processor, to cause the communication device to:
use a set of central office (CO) modems at a first distribution point to provide service to a first set of consumer premises equipment (CPE) modems over a first set of lines in a binder, wherein the binder further comprises a second set of lines associated with a second set of CPE modems serviced by a second distribution point;
detect crosstalk between the first set of lines and the second set of lines; and
communicate, based at least in part on the detected crosstalk, with the second distribution point over a crosstalk link, wherein the communicating uses one or more predefined tones within a first set of frequency bands or a second set of frequency bands.

22. The communication device of claim 21, wherein communicating with the second distribution point comprises:
coordinating use of the first set of frequency bands and the second set of frequency bands by the first distribution point and the second distribution point.

23. The communication device of claim 21, wherein communicating with the second distribution point comprises:
exchanging control and data messages with the second distribution point.

24. The communication device of claim 21, wherein the instructions are further executable by the processor to:
determine that the detected crosstalk does not satisfy a threshold; and
operate the set of CO modems and the first set of CPE modems on the first set of lines using one or both of the first set of frequency bands and the second set of frequency bands based at least in part on the determination.

25. The communication device of claim 24, wherein the instructions are further executable by the processor to:
receive, over the crosstalk link, an indication that the second distribution point is beginning service on the first set of frequency bands or the second set of frequency bands; and
adjust the operation of the set of CO modems and the first set of CPE modems to refrain from using the first set of frequency bands or the second set of frequency bands based at least in part on the received indication.

26. The communication device of claim 24, wherein the instructions are further executable by the processor to:
receive, over the crosstalk link, a first message, the first message comprising a request to use either the first set of frequency bands or the second set of frequency bands;
transmit, over the crosstalk link, a second message, wherein the second message is from a group consisting of: an acknowledgment of the request to use the first set of frequency bands or the second set of frequency bands and an indication that one of the first set of frequency bands or the second set of frequency bands are available; and
adjust the operation of the set of CO modems and the first set of CPE modems to refrain from using the first set of frequency bands or the second set of frequency bands based at least in part on the received request.

27. The communication device of claim 21, wherein the instructions are further executable by the processor to:
determine that the detected crosstalk satisfies a threshold;
transmit, over the crosstalk link, an indication that service on the first set of frequency bands or the second set of frequency bands is beginning based at least in part on the determination;
determine that the detected crosstalk no longer satisfies the threshold; and
operate the set of CO modems and the first set of CPE modems using one or both of the first set of frequency bands or the second set of frequency bands based at least in part on the crosstalk no longer satisfying the threshold.

28. The communication device of claim 21, wherein the instructions are further executable by the processor to:
determine that the detected crosstalk satisfies a threshold;
transmit, over the crosstalk link, a first message, wherein the first message comprises a request to use the first set of frequency bands or the second set of frequency bands based at least in part on the determination;
receive, over the crosstalk link, a second message, wherein the second message is from a group consisting of: an acknowledgment of the request to use the first set of frequency bands or the second set of frequency bands and an indication that one of the first set of frequency bands or the second set of frequency bands are available; and
operate the set of CO modems and the first set of CPE modems based at least in part the received second message.

29. The communication device of claim 28, wherein the instructions are further executable by the processor to:
detect synchronization information associated with the second distribution point; and
synchronize operating parameters for the set of CO modems and the first set of CPE modems based at least in part on the detected synchronization information.

30. A non-transitory computer readable medium storing code for wireline communications, the code comprising instructions executable by a processor to:
use a set of central office (CO) modems at a first distribution point to provide service to a first set of consumer premises equipment (CPE) modems over a first set of lines in a binder, wherein the binder further comprises a second set of lines associated with a second set of CPE modems serviced by a second distribution point;
detect crosstalk between the first set of lines and the second set of lines; and
communicate, based at least in part on the detected crosstalk, with the second distribution point over a crosstalk link, wherein the communicating uses one or more predefined tones within a first set of frequency bands or a second set of frequency bands.
